(19) United States
(12) Patent Application Publication
(10) Pub. No.: US 2011/0308919 A1
(43) Pub. Date: Dec. 22, 2011

(54) Method For The Installation And Removal Of A Conveyor Belt

(76) Inventor: André Hahn, Buizingen (BE)

(21) Appl. No.: 12/820,464

(22) Filed: Jun. 22, 2010

(30) Foreign Application Priority Data
Jun. 16, 2010 (EP) 10447014

(51) Int. Cl. B65G 45/00

(52) U.S. Cl. 198/617

(57) ABSTRACT

The invention relates to a method for the installation and removal of a conveyor belt (5) on drive rollers (1) by means of an endless supporting belt (2) stretched over said drive rollers, specifically a conveyor belt for a checkstand counter, so as to ensure the transit of said conveyor belt, which has an outer surface, an inner surface, and two transverse ends (15; 16).

The invention is characterized in that the installation process involves joining the conveyor belt and the supporting belt via their outer surfaces and via the use of junction means (14) constituting a hinge between these two belts, after which the two transverse ends of the conveyor belt are joined together via junction means (17) that are applied to the outer surface of said belt and that overlap said juxtaposed ends.

The present invention relates generally to a method for the installation and removal of a conveyor belt on drive rollers.

In particular, the invention relates to a method for the installation and removal of a conveyor belt on drive rollers by means of an endless supporting belt stretched over said drive rollers, specifically a conveyor belt for a checkstand counter, so as to ensure the transit of said conveyor belt, which has an outer surface, an inner surface, and two transverse ends.

The installation of a conveyor belt in a checkstand counter, e.g. a checkstand counter in a supermarket or in any other type of store, usually requires various manipulations including, in particular, the opening of the counter and the removal of various accessories before free access can be gained to the rollers intended to support and drive the belt, which must be installed and stretched over them. The entire set of operations required for this purpose, from the opening to the closing of the counter, usually requires 40 to 120 minutes. Because the working lifetime of a conveyor belt on a checkstand counter does not exceed 6 months of use, it is of primary importance to minimize the time required to remove a worn belt and to replace it with a new belt, so as to reduce the duration of the interruption in the use of the checkstand counter while also minimizing the corresponding inconveniences caused to employees.

Patent application No. WO 2006/066087 describes a method for installing a conveyor belt on a supporting belt. According to this method, a peripheral portion of the conveyor belt is secured to the supporting belt, wherein said peripheral portion includes both longitudinal and transverse portions, the latter being juxtaposed when the conveyor belt is stretched longitudinally over the supporting belt. This securing may be achieved through the application, to the outer surface of the supporting belt and to the inner surface of the conveyor belt, of an epoxy adhesive, a pressure-sensitive adhesive, double-sided adhesive strips (i.e., strips whose facing surfaces are covered with an adhesive material), or a system of self-gripping strips of the Velcro® type.

Multiple preliminary tests were performed, within the scope of the present invention, for securing a conveyor belt to a supporting belt in an effective, simple, and rapid manner. For this purpose, various methods were tested, including the one described in the above-mentioned patent application. For this purpose, various types of adhesive materials or systems were employed, including, in particular, an epoxy-type glue applied between the outer surface of the supporting belt and the inner surface of the conveyor belt, or double-sided adhesive strips which themselves were placed between the outer surface of the supporting belt and the inner surface of the conveyor belt. The use of glue-type adhesive materials showed that when the conveyor belt is removed, e.g. in order to be changed, traces of this adhesive material usually remain present on the outer surface of the supporting belt, which traces must be removed, e.g. using solvents, before installing a new conveyor belt and securing it to the supporting belt. Furthermore, when double-sided adhesive strips were used, they were found to be poorly secured to the inner surface of the conveyor belt, whose generally rough and irregular surface prevented any good-quality adhesion.

Moreover, during the development of the present invention, it was observed that the securing of the entire inner surface of the conveyor belt to the outer surface of the supporting belt causes, during the transit of the two belts thus joined, stresses and stretching that lead to the deformation of the assembly when it passes over the drive rollers. An analogous result was also noted when different portions of the conveyor belt, distributed throughout its length, were secured to the supporting belt according to the method described in the above-mentioned patent application No. WO 2006/066087.

In this patent application, two portions of the conveyor belt are defined respectively at each of the transverse ends of the belt. Each of these portions, whose width—as measured along the transverse axis of the belt—is equivalent to the width of the conveyor belt, and whose length—as measured along the longitudinal axis—is approximately 15 cm, is covered on its inner surface by adhesive means in order to be secured to the outer surface of the supporting belt. Consequently, the conveyor belt is secured transversely to the supporting belt by means of a zone whose width is represented by the width of these strips, and whose length, in the longitudinal direction, is approximately 30 cm.

The object of the present invention is to provide a method, of the type described hereinabove, that can simultaneously mitigate the foregoing disadvantages in that it allows a conveyor belt to be installed and removed significantly more quickly than in the prior method, by preventing the appearance of stretching or tension phenomena, or other deformations, and by eliminating the need to use the rough inner surface of the conveyor belt, while providing the secure fixation of this conveyor belt to the supporting belt.

To achieve this object, the method according to the invention is characterized in that the installation process involves the outer surface of the supporting belt, the outer surface of the conveyor belt, and junction means.

According to a further characteristic of the invention, the installation process involves joining the conveyor belt and the supporting belt via their outer surfaces and via the use of junction means constituting a hinge between these two belts.

Furthermore, according to another characteristic of the invention, the junction means constituting a hinge are represented by at least one adhesive strip.

Within the scope of the present specification and claims, the term ‘inner surface’ refers to the surface of a supporting belt, of a conveyor belt, or of an adhesive strip that faces the drive rollers, and the term ‘outer surface’ refers to the surface of a supporting belt, of a conveyor belt, or of an adhesive strip that does not face the drive rollers.

Similarly, the term ‘adhesive strip’ refers to an adhesive system that includes a substrate sheet, e.g. a sheet of natural or synthetic material, such as a sheet of fabric or relatively flexible plastic material, one of whose surfaces is covered by an adhesive material. This adhesive material is chemically neutral toward the constituents of the supporting belt and of the conveyor belt with which it comes into contact.

Thus, according to the invention, the conveyor belt is joined to the supporting belt solely by means of the outer surface of each of these strips, to the exclusion of any adhesive contact between them. This joint may be implemented by means of at least one adhesive strip, typically a single strip, positioned on both the outer surface of the supporting belt and the outer surface of the conveyor belt. This adhesive strip thus serves as a hinge between the supporting belt and the conveyor belt.

Such an embodiment, which makes it possible to avoid any adhesive contact between the conveyor belt and the supporting belt, consequently eliminates any possibility of deformation that might appear when these strips adhere to each other.

Thus, according to a preferred embodiment of the invention, the conveyor belt and the supporting belt are joined via the application of an adhesive strip that overlaps both a first portion of the outer surface of the conveyor belt, with this first portion being located at one of the transverse ends of the conveyor belt, and a portion of the outer surface of the supporting belt.

Furthermore, according to another characteristic of the invention, in order to perform the installation when the conveyor belt is joined to the supporting belt, the two transverse ends of the conveyor belt are themselves joined to each other via junction means that are applied to the outer surface of said belt and that overlap said juxtaposed ends.

According to another characteristic of the invention, the junction means are represented by at least one adhesive strip.

Thus, the joint between the two transverse ends of the conveyor belt is achieved not via the adhesion of portions of transverse ends, but rather via the use of junction means, typically consisting of at least one adhesive strip, usually a single strip, applied to the outer surface of this belt and overlapping these two juxtaposed ends. This adhesive strip is typically analogous to the one that is employed to join the conveyor belt to the supporting belt.

Consequently, according to another preferred embodiment of the invention, when the conveyor belt is joined to the supporting belt and is stretched longitudinally over it, and when the two transverse ends of this conveyor belt are juxtaposed, said transverse ends are joined together through the application, to the outer surface of said conveyor belt, of an adhesive strip that overlaps these two transverse ends and that covers a second and a third portions of this outer surface, which portions are defined respectively on these two transverse ends.

In the light of the foregoing, it should be noted that the method according to the invention, taken as a whole, involves, at any stage whatsoever of its implementation, only adhesive strips and the outer surfaces of the supporting and conveyor belts, to the exclusion of their inner surfaces.

However, the adhesion of these adhesive strips to the outer surfaces of the supporting and conveyor belts achieves its maximum effectiveness only if these surfaces possess little or no roughness or irregularities in the areas in which these adhesive strips are to be placed.

Consequently, according to a further characteristic of the invention, the adhesive strips are placed in flat areas of the outer surface of the supporting belt and in flat areas of the outer surface of the conveyor belt.

The width, in the transverse direction of the supporting and conveyor belts, of the adhesive strips that are employed in the method according to the invention is preferably equivalent to the width of these belts. However, if necessary, these strips may be split into multiple portions, which may or may not be juxtaposed.

Furthermore, the length of these strips—as measured in the longitudinal direction of the belts—should be sufficient to ensure, on the one hand, the secure fixation of the conveyor belt to the supporting belt, and, on the other hand, the secure fixation to each other of the ends of the conveyor belt, preferably, however, without exceeding certain limits imposed essentially by the drive rollers. In point of fact, an adhesive strip that possesses a certain degree of rigidity and that is too long poses the risk of creating stress zones and, consequently, weaknesses during its passage over the drive rollers. As a result, this phenomenon may lead to deterioration in the region in which the adhesive strips adhere to the conveyor and supporting belts.

For this reason, and according to another characteristic of the invention, the maximum cumulative length of the first portion of the outer surface of the conveyor belt and of the portion of the outer surface of the supporting belt is equal to the length of the diameter of the drive rollers.

Similarly, according to a further characteristic of the invention, the maximum cumulative length of the second and third portions of the outer surface of the conveyor belt is equal to the length of the diameter of the drive rollers.

To uninstall the conveyor belt, the adhesive strips are removed, e.g. by being lifted away, and the conveyor belt is removed.

In the light of the foregoing, and according to a preferred embodiment of the invention:
A) to perform the installation:
   a) the conveyor belt and the supporting belt are joined via the application of an adhesive strip that overlaps both a first portion of the outer surface of the conveyor belt, with this first portion being located at one of the transverse ends of the conveyor belt, and a portion of the outer surface of the supporting belt,
   b) when the conveyor belt is joined to the supporting belt and is stretched longitudinally over it, and when the two transverse ends of this conveyor belt are juxtaposed, said transverse ends are joined together through the application, to the outer surface of said conveyor belt, of an adhesive strip that overlaps these two transverse ends and that covers a second and a third portions of this outer surface, which portions are defined respectively on these two transverse ends;
B) to uninstall the conveyor belt, the adhesive strips are removed and then the conveyor belt is removed.

The supporting belt used for the purposes of the present invention typically includes an antistatic substrate sheet made of flexible material, e.g. a sheet of fabric or a sheet of woven felt, that can reduce the stretching phenomenon, or more generally, a sheet of material, such as certain polyesters, that possess a high degree of tensile strength as well as a high degree of dimensional stability or shape stability. This substrate sheet is usually covered by a layer of flexible material that defines the flat outer surface of the supporting belt, which surface is free from rough areas. For example, it may consist of a natural or synthetic elastomer, such as natural or synthetic rubber, or a thermoplastic polymer material, such as polyvinyl chloride or polyurethane.

This supporting belt, whose ends are brought together so as to form an endless belt, is installed on drive rollers and stretched over them. Securing is customarily achieved through any appropriate means, such as stapling or high-frequency heat-welding.

The conveyor belt likewise consists essentially of an antistatic substrate sheet made of a flexible material, such as a sheet of fabric or a sheet of woven felt, that can display a high degree of tensile strength, resist abrasion and aging, and also reduce the stretching phenomenon. This sheet typically has the same properties as the sheet used for the supporting belt, in that it possesses a high degree of tensile strength and a high degree of resistance to three-dimensional deformations. For example, it may consist of a sheet of antistatic fabric, antistatic woven felt, or polyester.

This sheet is covered by a layer of flexible material that defines the outer surface of the conveyor belt, this surface being flat and free from rough areas. This coating is obtained from a natural or synthetic elastomer, such as natural or synthetic rubber, or a thermoplastic polymer material, such as polyvinyl chloride or polyurethane. The latter material is particularly preferred when this coating is intended to receive printed images, as described in European patent application No. EP 1,788,544. In this case, the polyurethane intended to receive this printing is initially preferably white, which coloration typically results from dyes or pigments incorporated directly into the body of the material.

The polyurethane coating is commonly obtained through the application of a powdered polymer to the substrate sheet, followed by heating to liquefaction and then by uniform distribution over said sheet. However, this method has the disadvantage of producing a non-homogeneous polymer layer, because of the presence of residual air bubbles in the body of the material or of air bubbles that are introduced through the permeable substrate sheet. As a result, these bubbles cause weaknesses within this layer, which weaknesses are manifested as cracks that appear after the transit of the conveyor belt, and particularly after its passage over the drive rollers.

Nevertheless, within the scope of the present invention, it was demonstrated that the use of polyurethane in the form of a paste deposited onto the substrate sheet of the conveyor belt, and then heated to fluidization and distributed uniformly over this substrate sheet, makes it possible to mitigate this disadvantage and thereby prolong the lifetime of the conveyor belt. After being manufactured, this belt has a perfectly flat visible outer surface that is free from rough areas and that may be used as is, or, preferably, may be covered with coloration zones that may combine written text and decorative or other graphic designs that may or may not correspond, for example, to trademarks, slogans, promotional or non-promotional announcements, or any type of information intended for the general public.

These coloration zones are typically obtained by printing, in accordance with the method described in European patent application No. EP 1,977,982, whose stages can be summarized as follows:
a) degreasing of the conveyor belt in question, on the surface intended to receive the printing;
b) treatment, with an excimer laser, of said surface, so as to increase its surface energy;
c) creation of a digital image, e.g. an image associated with an advertisement, and storage of said image on an appropriate medium;
d) transmission of this digital image to a plotter or printer;
e) printing of the image on said surface, through the formation of at least one layer of ink obtained by spraying the ink from the plotter or printer;
f) drying of the ink used in the printing, via ultraviolet radiation or in the presence of oxygen, depending on the type of ink;
g) covering of said surface with at least one layer of a material, or a mixture of materials, intended to protect the printed image;
h) drying of the layer of protective material(s).

The invention will be readily understood, and other objects, characteristics and advantages thereof will appear more clearly, from the following detailed description, with reference to the accompanying diagrammatic drawings, provided only as non-limiting examples and illustrating one embodiment of the invention, in which:

FIG. 1 is a schematic cross-sectional representation of a conveyor belt, installed and stretched, according to the state of the art, on a supporting belt installed on drive rollers;

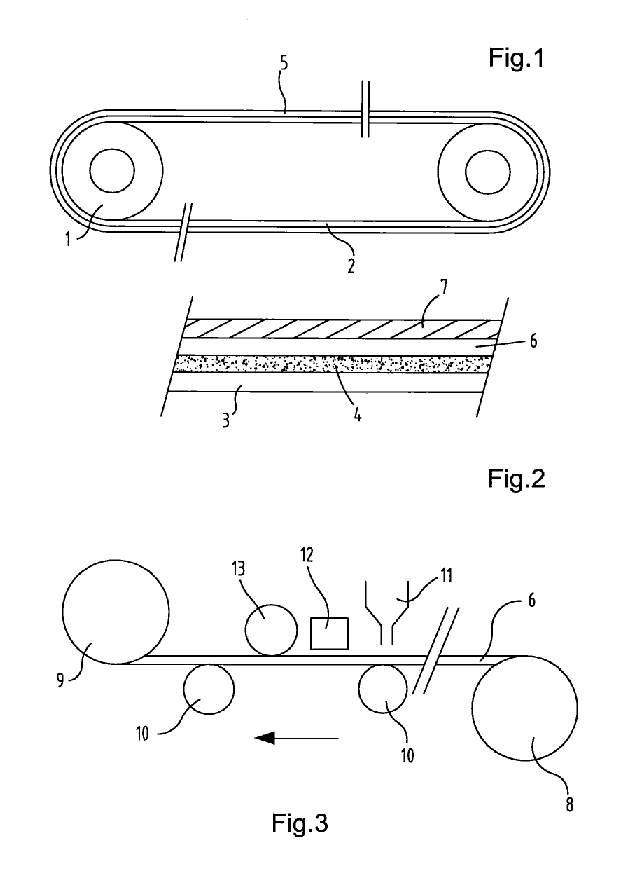

FIG. 2 is a partial schematic cross-sectional representation of the conveyor belt shown in FIG. 1, placed on a supporting belt;

FIG. 3 is a schematic view of the coating stage in the method for manufacturing a conveyor belt;

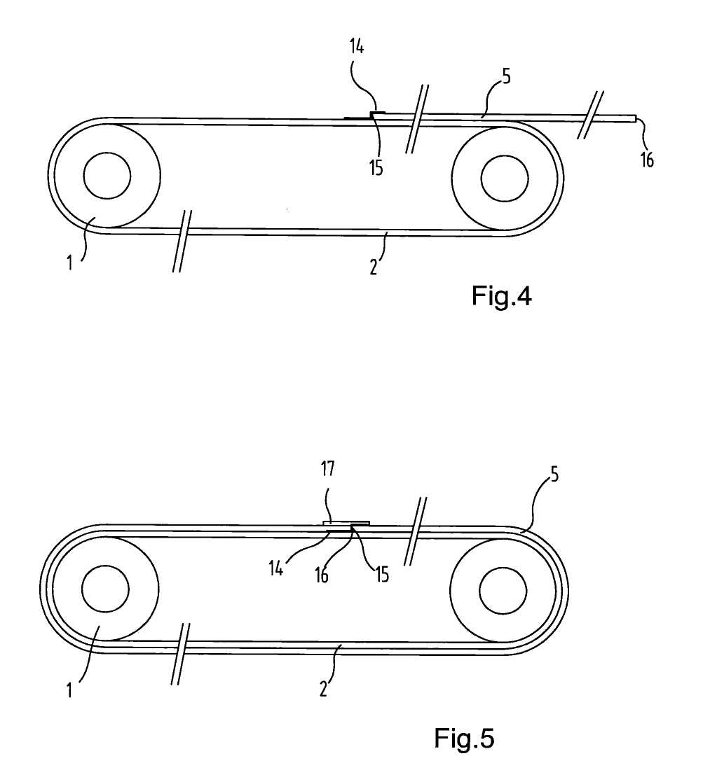

FIG. 4 is a schematic cross-sectional representation of a conveyor belt secured, according to the invention, to a supporting belt;

FIG. 5 is a schematic cross-sectional representation of the conveyor belt shown in FIG. 4, stretched over the supporting belt.

As shown in FIG. 1, rollers 1 that can rotate on their axes under the action of any drive device (not shown), such as a gear motor, support an endless supporting belt 2 that is installed and stretched over the rollers. As shown in FIG. 2, the latter belt consists of a substrate sheet 3, made of a technical fabric approximately 3,350 cm long, to which a polyvinyl chloride coating 4 is uniformly applied so as to form a flat surface.

FIG. 1 also shows, simply installed over the entire supporting belt, a conveyor belt 5 that consists, as shown in FIG. 2, of a substrate sheet 6 made of a technical fabric covered by a polyurethane coating 7 distributed in a flat and uniform manner and bearing printed images (not shown).

As shown in FIG. 3, this conveyor belt 5 may be manufactured from a substrate sheet 6 that is unrolled continuously from a feeder reel 8 to a take-up spool 9, after passing over one or more supporting rollers 10. During its course of travel, this substrate sheet receives, by means of an injector 11, a given quantity of polyurethane in the form of a paste whose body is tinted white. This paste, which is fluidized by any heating device 12, forms a polyurethane layer that is distributed uniformly by means of an equalizer roller 13 and then cooled in open air downstream of this roller.

The surface intended to form the visible surface of the conveyor belt 5 is then degreased in order to eliminate solid and/or liquid debris, in particular greasy residues resulting from the manufacture of the polyurethane coating. This layer then undergoes treatment with an excimer laser in order to increase its surface energy. After this operation, a previously created digital image is sent by a computer to a plotter that prints said image by spraying jets of ink onto the treated surface. The layer of sprayed ink is dried, either under an oxygenated atmosphere or by ultraviolet radiation, depending on the nature of this ink.

After the conveyor belt has been cooled in a stream of air near or below room temperature, a layer of colorless protective varnish is applied to the ink layer and dried via radiation.

In order to secure the conveyor belt 5 to the supporting belt 2, first of all, as shown in FIG. 4, a single adhesive strip 14 is applied simultaneously to one portion of the conveyor belt 5, which portion is located at one of the ends thereof, i.e. end 15, and to one portion of the outer surface of the supporting belt 2. This strip 14 has only one adhesive surface. It covers transversely the entire width of these belts, and extends longitudinally by a length of approximately 1-2 cm over the conveyor belt, and by a length of 3-5 cm over the supporting belt.

In the longitudinal direction, the conveyor belt is then stretched over the outer surface of the supporting belt, and the second end of the conveyor belt, i.e. end 16, is juxtaposed with end 15, with only the thickness of the strip 14 separating these two ends. Then an adhesive strip 17, which is analogous to strip 14, is applied to the outer surface of the conveyor belt, with said adhesive strip covering the entire width of the conveyor and supporting belts in the transverse direction, and covering essentially the length of the strip 14 in the longitudinal direction.

The conveyor belt installed in this manner can be uninstalled by lifting away the strip 17 and then the strip 14, whereupon the belt is removed.

The method according to the invention, as described herein, can be implemented within a minimal period of time that typically does not exceed 45 minutes. Furthermore, this method is extremely simple, because only minimal portions of the surface area of the supporting belt and of the conveyor belt are necessary in order for these belts to be joined. As a corollary, this minimal surface area has been shown to be incapable of causing stresses or deformations during the movement of the assembly formed by these belts. Moreover, this method avoids the use of adhesive materials that might soil the supporting belt when the conveyor belt is removed.

1. A method for the installation and removal of a conveyor belt (5) on drive rollers (1) by means of an endless supporting belt (2) stretched over said drive rollers, specifically a conveyor belt for a checkstand counter, so as to ensure the transit of said conveyor belt, which has an outer surface, an inner surface, and two transverse ends (15; 16), characterized in that the installation process involves the outer surface of the supporting belt, the outer surface of the conveyor belt, and junction means.

2. The method according to claim 1, characterized in that the installation process involves joining the conveyor belt and the supporting belt via their outer surfaces and via the use of junction means constituting a hinge between these two belts.

3. The method according to claim 2, characterized in that the junction means constituting a hinge are represented by at least one adhesive strip.

4. The method according claim 1, characterized in that, in order to perform the installation when the conveyor belt is joined to the supporting belt, the two transverse ends of said conveyor belt are themselves joined to each other via junction means that are applied to the outer surface of said belt and that overlap said juxtaposed ends.

5. The method according to claim 4, characterized in that the junction means are represented by at least one adhesive strip.

6. The method according to claim 3, characterized in that the adhesive strips are placed in flat areas of the outer surface of the supporting belt and in flat areas of the outer surface of the conveyor belt.

7. The method according to claim 1, characterized in that the conveyor belt and the supporting belt are joined via the application of an adhesive strip (14) that overlaps both a first portion of the outer surface of said conveyor belt, with this first portion being located at one of the transverse ends (15) of said conveyor belt, and a portion of the outer surface of said supporting belt.

8. The method according to claim 7, characterized in that the maximum cumulative length of the first portion of the outer surface of the conveyor belt and of the portion of the outer surface of the supporting belt is equal to the length of the diameter of the drive rollers.

9. The method according to claim 1, characterized in that, when the conveyor belt is joined to the supporting belt and is stretched longitudinally over it, and when the two transverse ends (15; 16) of said conveyor belt are juxtaposed, said transverse ends are joined together through the application, to the outer surface of said conveyor belt, of an adhesive strip (17) that overlaps these two transverse ends and that covers a second and a third portions of said outer surface, which portions are defined respectively on these two transverse ends.

10. The method according to claim 9, characterized in that the maximum cumulative length of the second and third portions of the outer surface of the conveyor belt is equal to the length of the diameter of the drive rollers.

11. The method according to claim 1, characterized in that, to uninstall the conveyor belt, the adhesive strips are lifted away and the conveyor belt is then removed.

12. The method according to claim 1, characterized in that:
A) to perform the installation:
a) the conveyor belt and the supporting belt are joined via the application of an adhesive strip (14) that overlaps both a first portion of the outer surface of the conveyor belt, with this first portion being located at one of the transverse ends (15) of the conveyor belt, and a portion of the outer surface of the supporting belt,
b) when the conveyor belt is joined to the supporting belt and is stretched longitudinally over it, and when the two transverse ends (15; 16) of said conveyor belt are juxtaposed, said transverse ends are joined together through the application, to the outer surface of said conveyor belt, of an adhesive strip (17) that overlaps these two transverse ends and that covers a second and a third portions of said outer surface, which portions are defined respectively on these two transverse ends;
B) to uninstall the conveyor belt, the adhesive strips are removed and then the conveyor belt is removed.

13. The method according to claim 1, characterized in that the supporting belt includes, applied to a substrate sheet (3), a polyvinyl chloride coating (4) that defines the outer surface of this supporting belt.

14. The method according to claim 1, characterized in that the conveyor belt includes, applied to a substrate sheet (6), a polyurethane coating (7) that defines the outer surface of this conveyor belt.

15. The method according to claim 14, characterized in that the polyurethane coating is obtained from polyurethane in the form of a paste deposited onto the substrate sheet.
